(19) United States
(12) Patent Application Publication
(10) Pub. No.: US 2021/0005086 A1
(43) Pub. Date: Jan. 7, 2021

(54) Devices and methods for preventing automotive collisions with wildlife

(71) Applicant: Jessica Cohen, Niagara Falls, NY (US)

(72) Inventor: Jessica Cohen, Niagara Falls, NY (US)

(73) Assignee: Lake of Bays Semiconductor Inc., Niagara Falls, NY (US)

(21) Appl. No.: 16/504,259

(22) Filed: Jul. 6, 2019

(51) Int. Cl. G08G 1/16; B60W 30/09; A01M 29/18; G06K 9/00

(52) U.S. Cl. CPC G08G 1/166; B60W 30/09; B60W 2400/00; G06K 9/00362; A01M 29/18

(57) ABSTRACT

Described herein is an autonomous vehicle collision avoidance system designed to detect and deter animals from the road. An automotive ‘deer whistle’ is integrated into an autonomous sensor suite. The sensor suite detects animals using cameras, identifies them and their hearing range using machine learning algorithms, and deters them by emitting animal-specific sound pulses. The system also notifies the driver, may trigger a braking or honking sequence, adjusts subsequent noise emissions based on animal feedback, and collect data on collisions or near collisions for analysis at a central repository. Also described herein is a business model to encourage consumer adoption of the device, wherein the device is distributed to consumers as insurance policy incentive.

### FIELD OF THE INVENTION

The fields of the invention are advanced driver assistance systems, vehicle safety technologies, sound production, and applied machine learning.

### BACKGROUND

Presently there are over 1,300,000 collisions between vehicles and animals, mostly deer, annually in the United states, resulting in 150 deaths and $5,000,000,000 in auto insurance claims. While some automotive manufacturers have expressed an interest in solving this problem, they address it the same as a pedestrian forward collision avoidance system, by activating a braking system. This philosophy is flawed when addressing animals, because animals are not cognitively trained to move away from an oncoming vehicle, nor does braking always produce the safest result. What is needed is a system that identifies an animal's hearing range and communicates to it essentially instructions to move away from the vehicle, to prevent a collision.

The state of the art describes automotive pedestrian crash avoidance systems which identify pedestrians from image data collected from a few types of sensors, to accommodate varying visibility and atmospheric conditions. These systems usually executing automatic braking. Volvo and BMW demonstrate technology to see animals during day and night. Academic researchers have shown methods to detect animals from video using machine learning, and other object detection subtleties. However the combination of automatic braking in response to a detected animal is not sufficient to avoid collision: the animal might run towards the vehicle; braking and swerving may still produce a collision if other vehicles are behind the affected driver. Moving animals off the road is a more effective method of reducing collisions than braking, swerving, honking, or flashing headlights.

Commercial electronic devices exist which successfully deter a range of animals by emitting ultrasonic waves. These devices are optimized for cats in backyards, deer near railway cars, rats in basements, and deer near vehicle grills. Some yard devices are ‘smart’ in that they combine a motion sensor, which, in the presence of an animal, triggers the ultrasonic wave emission. However a moving vehicle on a road with other cars poses additional complexities. Consumers are also concerned about sonic waves irritating canine passengers in their cars.

US-based studies indicate that commercial deer whistles are not effective at deterring deer; however, the studies also indicate that poor construction, low volume, and wrong frequency are the causes. Japanese studies indicate that deer can hear the devices but only specific frequencies, and are more responsive to changing frequencies. Thousands of online consumer reviews indicate that the better-constructed devices do work, but these reports are anecdotal. There is no argument among the scientific or consumer communities regarding the effectiveness of stationary ultrasonic repellants for the yard or the kitchen.

What is needed is a more robust device, with automated feedback, frequency modulation, and on-off control. What is also needed is a system or device which detects and classifies animals from image data from a moving vehicle, then autonomously repels them by means of a biologically-appropriate sound wave. Finally, what is needed is a financial incentive for drivers to install these devices on their cars. These are all means to the end of fatalities and property damage due to animal collisions.

### BRIEF DESCRIPTION OF DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 shows how a computer vision system of Claim \* MERGEFORMAT 1 identifies and classifies animals from sensor data collected from a vehicle's field of view.

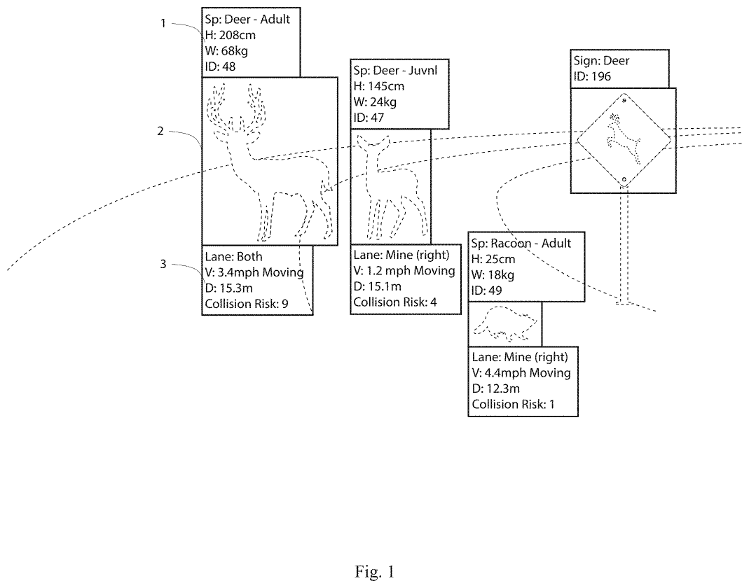

FIG. 2 shows an interface optimized for mobile device, such as a smartphone displaying relevant crash and animal statistics to drivers relevant to their present route, with options to continuously operate the ultrasonic whistle, or change their route, as described in claim 5.

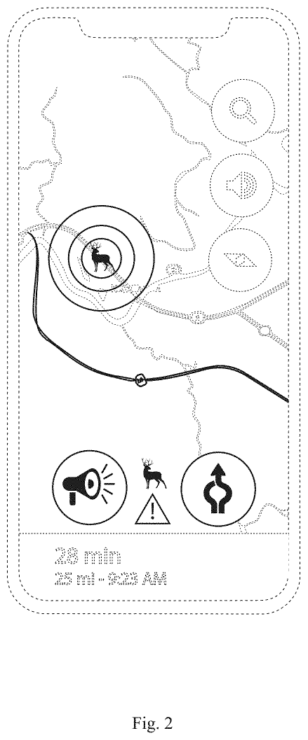

FIG. 3 shows an interface optimized for a desktop monitor displaying data aggregated from events logged by multiple users of the present invention, as described in claims 2 and 7.

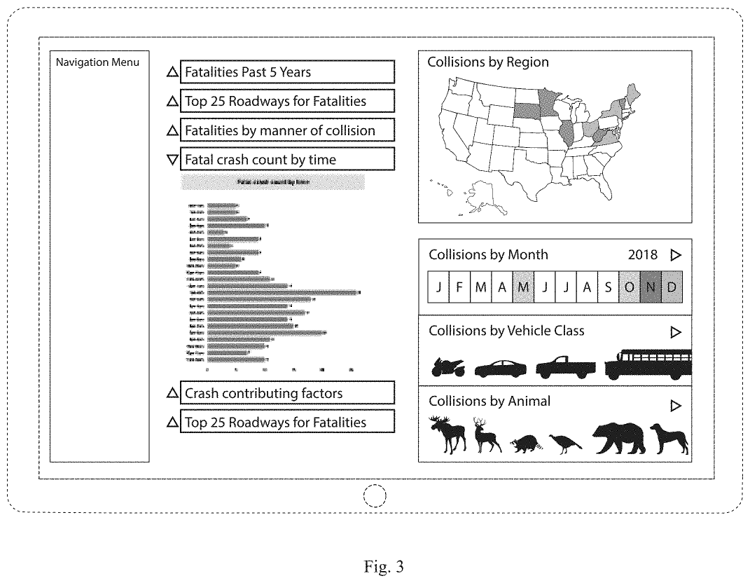

FIG. 4 shows a device for detecting and deterring deer, as described in claims 1 and 3.

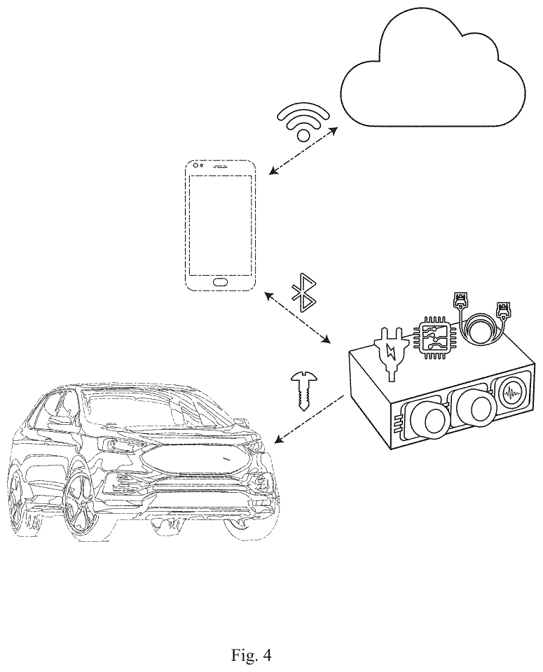

FIG. 5 shows a flow chart of the computer vision algorithm's process as described in claim 1.

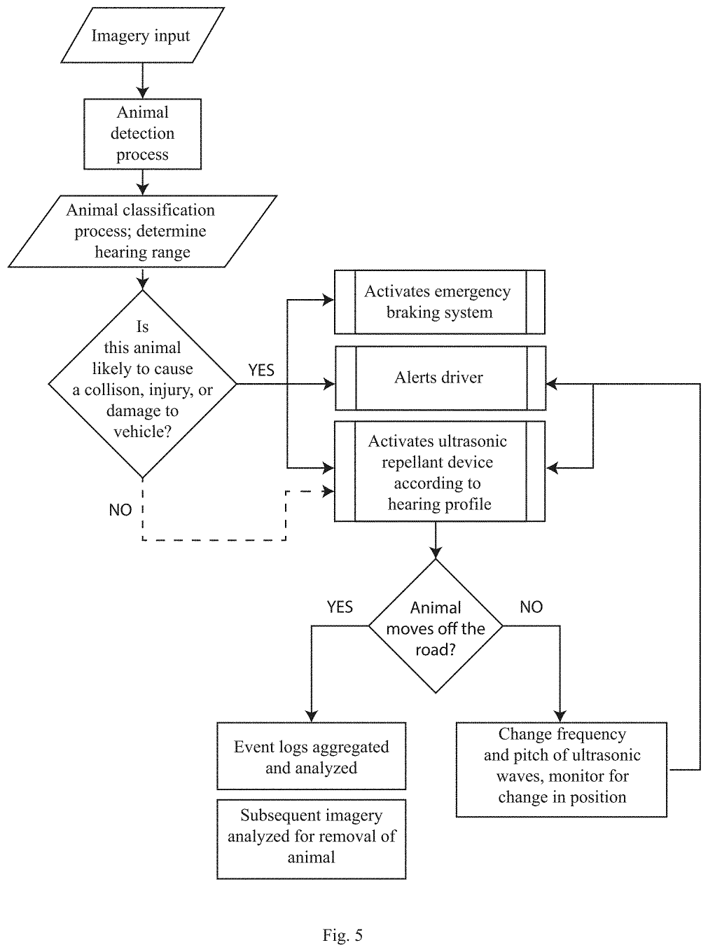

### DESCRIPTION OF THE PREFERRED EMBODIMENTS

An autonomous driver assistance system incorporates a variety of sensors (infrared, radar, lidar, ultrasonic, visible light cameras, etc.), a processor programmed with animal detection algorithms, networking capabilities, power supply, a multi-frequency ultrasonic animal repellant device, are mounted on a vehicle. The sensors collect image data of the vehicle's surroundings, then computer vision algorithms pre-programmed in the computer identify and classify animals according to their species, age, speed, location in relation to the vehicle, so that the system may estimate its hearing range, and the likelihood and severity of a collision with the vehicle. The system then autonomously triggers an ultrasonic device, on the vehicle's exterior, to emit sound waves to repel the specific animal profile. The system also alerts the driver to the presence of the animal on the road, and may also initiate a braking or honking sequence. The sensors may observe if the animal responds to the sound, by analyzing video for movement, and if not, the system triggers additional sound waves of different frequency and duration. The system transmits data from these events to an external computer for aggregation and analysis. The data is displayed on web and mobile interfaces which allows user to search, generate reports, and adapt driving behavior.

In the preferred embodiment, the system identifies an animal on the road using sensors, estimates an animal's hearing range, and essentially instructs it to move away from the oncoming vehicle by emitting sonar pulses.

In a second embodiment, a multi-frequency ultrasonic pulse generator is mounted on a vehicle's exterior, which connects to the vehicle's power supply, and also connects to the driver's smartphone inside the vehicle, whereby the smartphone activates the ultrasonic device, according to pre-loaded location-specific instructions, and collects and provides data to the driver. A driver may also manually activate or deactivate the device with a voice or touch command to the phone.

In a third embodiment, a multi-frequency ultrasonic pulse generator connects to a vehicle's autonomous driver assistance system, whereby the ADAS system provides the system's sensing, networking, and computing functions.

In a fourth embodiment, an ultrasonic pulse generator and an ultrasonic parking sensor are combined into a single device, capable of emitting and receiving multiple sound wave frequencies to repel animals and also to locate objects in the vehicle's proximity.

### PRIOR ART (PATENT FILINGS)

| Number | Title | Inventor | Filing Date |
|---|---|---|---|
| JP2015006153A | Deer repellent sound-generating device, | Etsuro | 2017 Dec. 27 |
| | deer intrusion prevention system in railroad | Kitayuguchi | |
| | track, vehicle, and deer repellent method | | |
| US20160066559A1 | Apparatus and method for using uv light to | David F. | 2014 Sep. 10 |
| | reduce collisions with animals | Russell | |
| JP3209309U | Intrusion Prevention System | | 2016 Dec. 26 |
| US7284769B2 | Method and apparatus for sensing a vehicle | David S. | 1995 Jun. 7 |
| | crash | Breed | |
| JP2013158334A | Animal repelling apparatus | Hiroyuki | 2012 Feb. 9 |
| | | Negishi | |
| US7841291B1 | Ultrasonic and/or infrasonic animal | Philip John | 2009 Jan. 6 |
| | repellent horn powered by compressed air | Milanovich | |
| | canister combined with a strobe light | | |
| JP2006502729A | System to avoid that the vehicle collides | | 2002 Oct. 15 |
| | with an animal | | |
| US20180310526A1 | Animal control around restricted zones | Thomas A. | 2017 Apr. 28 |
| | | Birch | |
| JP2018050503A | System and method for repelling or | | 2016 Sep. 27 |
| | exterminating harmful animal | | |
| US9858621B1 | Autonomous vehicle technology | Blake | 2014 May 20 |
| | effectiveness determination for insurance | Konrardy | |
| | pricing | | |
| US8484113B2 | Incentivized adoption of time-dependent | Fred | 2008 Nov. 26 |
| | insurance benefits | Collopy | |
| US20040117217A1 | Financial incentive through insurance | Richard | 2002 Dec. 17 |
| | offerings for vehicles that utilize a safety | Reber | |
| | system | | |
| US20090062990A1 | Systems and Methods for Encouraging the | William S. | 2007 Aug. 28 |
| | Use of Vehicle Seat Belts | Materna | |

### PRIOR ART (NON-PATENT FILINGS)

Zhang, Zhi “Animal Detection From Highly Cluttered Natural Scenes Using Spatiotemporal Object Region Proposals and Patch Verification”, IEEE Transactions on Multimedia >Volume: 18 Issue: 10 , 27 July 2016.

Gyanendra K. Verma, Pragya Gupta, “Wild Animal Detection from Highly Cluttered Images Using Deep Convolutional Neural Network”, International Journal of Computational Intelligence and Applications, pp. 1850021, 2018.

M. I. Chacon-Murguia and S. Gonzalez-Duarte , An adaptive neural-fuzzy approach for object detection in dynamic backgrounds for surveillance systems, IEEE Trans. Ind. Electron. 59 (8) (2012) 3286-3298.

A. Mammeri, D. Zhou, A. Boukerche and M. Almulla , An efficient animal detection system for smart cars using cascaded classifiers, in IEEE Int. Conf. Communications (ICC), Sydney, NSW, 2014, pp. 1854-1859.

Shikano et al. “Effectiveness of Deer whistle for Hokkaido sika deer for prevention of deer-vehicle crash”. Wildlife Conservation Japan 2, (2): 39-46 2010.

1. An automotive collision avoidance system comprised of:
a. an ultrasonic pulse emitting device, which is further comprised of a siren waveform generator, an output driver, an electro-acoustic transducer, an amplifier, a processor mounted on a printed circuit board, a controller, networking hardware, a power source, which emits a range of sound frequencies between 10 -100 kHz, in a plurality of pulse patterns,
b. and an impact and debris resistant shell,
c. machine learning algorithms,
d. sensors, which may include infrared cameras, RGB (visible light) cameras, LiDAR sensors, radar sensors, or combination thereof,
e. connection to a local computer with a display, such as a driver's smartphone, or the vehicle's onboard computer,
f. connection to a remote database, from said device or from the local computer, whereby, the sensors feed image data from the environment to the processor, whereby the machine learning algorithms detect and classify an animal or animals in the device's field of view; whereby upon receipt of instructions from the machine learning algorithm regarding the animal's presence and hearing range, the device initiates a biologically-appropriate ultrasound pulse or pulses, may also initiate an emergency braking or honking sequence, and may also alert the driver via the connected computer; whereby, after emitting said pulses, the device compares the animal's position and movement to before the pulse emission, and if no change is detected, the device emits subsequent ultrasound pulses of different frequency and rate to deter the animal; whereby all data regarding the incident is transmitted to a central repository for analysis.

2. A computer vision system comprised of machine learning algorithms of claim 1 which are trained to detect animals from dynamic input from automotive sensors, such as infrared cameras, thermal cameras, visual spectrum cameras, ultrasonic sensors, or lidar sensors, to identify the presence of an animal in the vehicle's proximity, its position in relation to the road and the vehicle, if it is moving or stationary, and if moving, its speed and direction in relation to the road shoulder and the vehicle; to classify the animal according to species and size, to match these attributes to a species profile from within a library of profiles, and to infer hearing range; wherein the animals of interest are primarily deer, moose, elk, reindeer, dogs, bears, turkeys, racoons, kangaroos, sloths, or other animals which are statistically likely to be involved in fatal automotive collisions.

3. A collision scoring algorithm, based on data generated by the system of claim 1, which generates a score of likelihood of collision between the animal and the vehicle, which is calculated by comparing the weight and height of the animal to that of the vehicle, the number of animals in the vehicle's path, which is weighted by data from a database of previous the number of collisions which have previously occurred in that geolocation, data from a database of previous collisions in that geographic area, and also assigns a dollar value to each instance of an identified animal on the road, which represents the potential automobile repair and medical costs should the animal impact the vehicle, based on the vehicle's known size, weight, speed, and repair costs, and based on the animal's inferred size, weight, and speed; displays this data to the driver, and transmits this data to a remote processing center; whereby said data is aggregated and analyzed for improved safety and performance validation.

4. An automotive ultrasonic device which generates multiple frequencies of ultrasonic pulses between 10 -100 kHz, for the purpose of deterring animals of various species, and also generates and receives ultrasonic sound waves between 30-50 kHz, for the purpose of parking and object detection in the proximity of a vehicle; whereby the device combines the functionality of a pest repellent and a parking sensor; whereby the device receives operating instructions from an onboard computer; whereby the device is mounted on the exterior of a vehicle.

5. An automotive deer deterring system comprised of:
a. A multi-frequency piezo-electric siren,
b. A mobile application with a user interface for operating the siren displayed on a smartphone, which is further comprised of a maps API, which displays location-based and seasonal statistics of animal collisions in relation to a user's route, visual representations of geographic risk areas determined from remotely-stored and continuously updated animal collision statistics, and buttons for altering a driving route and operating the piezo-electric siren,
c. Communications protocols, such electrical wiring or Bluetooth,
whereby the siren is mounted on the exterior of the vehicle, and is connected to a smartphone inside the vehicle, whereby the smartphone displays the driver's location and alerts the driver to a high-risk area, automatically activates the siren, and further alters the driver to alternate routes outside of the risk area, and, if the driver sees that the animal is not responding to the siren, further enables the driver to modify and replay the sound at a different frequency or timing; wherein the application or the driver deactivates the siren upon exiting the high-risk area; wherein the driver may also operate the device by voice command or by touching digital buttons on the display; whereby the application collects data from each incident and transmits said data to a cloud service which analyzes the data.

6. A insurance incentive method which comprises an automotive ultrasonic animal repellant device and system of claim 1, wherein the insurer lowers the driver's premium, deductible, or combination thereof, in return for installing and operating said device on their vehicle, and for enabling transmission of automotive telemetry data on the driver's behavior and animal collision incidents to the insurer.

7. An analytics platform which aggregates data from installations of the device of claim 1, including the quantity, species, size, location of animals, collision or near-collision incidents, responsiveness to the operating ultrasonic frequency, and other data; analyzes the data for trends, such as weather, season, location, collision cost and frequency, or fatalities; updates the device's maps' geographic risk areas; and provides analysis of that data to insurers, road authorities, and other agencies.
